(19) United States
(12) Patent Application Publication
(10) Pub. No.: US 2009/0289954 A1
(43) Pub. Date: Nov. 26, 2009

(54) Rendering Display Device

(75) Inventors: Manami Naito, Tokyo (JP); Atsushi Tanaka, Tokyo (JP); Toshiyuki Hagiwara, Tokyo (JP); Yasunori Tsubaki, Tokyo (JP)

Correspondence Address: BIRCH STEWART KOLASCH & BIRCH, PO BOX 747, FALLS CHURCH, VA, 22040-0747, US

(73) Assignee: MITSUBISHI ELECTRIC CORPORATION, Chiyoda-ku, Tokyo (JP)

(21) Appl. No.: 11/991,608

(22) PCT Filed: Sep. 8, 2005
(86) PCT No.: PCT/JP2005/016482

§ 371 Date: Mar. 7, 2008

(51) Int. Cl. G09G 5/00

(52) U.S. Cl. 345/629

(57) ABSTRACT

In displaying overlapped images on a monitor, a rendering display device is provided for the purpose of easily overlapping images without having complicated mask data or the like.

In the rendering display device, when at least one of image data stored in non-display memories is updated and if there exists an image whose layout information specifies that its image is displayed in the foreground of images corresponding to the updated image data, the updated image data and the image data specified to be displayed in the foreground are transferred to an entire-image non-display memory.

### TECHNICAL FIELD

The present invention relates to rendering display devices that display images onto a monitor.

### BACKGROUND ART

In conventional rendering display devices, when a plurality of images is overlapped to be displayed on a monitor and if there exist frequently updated images such as moving images, it has been necessary that image data is rendered, by using mask data or complicated processes such as a rectangle area management, to display on the monitor. Furthermore, there has been an image display system (for example, Patent Document 1) in which data different in frame rate are effectively synthesized only in a single frame memory to display on a monitor.

Patent Document 1: Japanese Patent Laid-Open No. H07-104722 (FIG. 1)

### DISCLOSURE OF INVENTION

In the image display system disclosed in Patent Document 1, there have been problems in that sequence for overlapping, status of updating and the like are not administered. When a plurality of images is overlapped to be displayed on a monitor, the present invention aims to provide a rendering display device that can easily overlap the images without complicated mask data and the like.

A rendering display device according to the present invention includes: a non-display memory for storing image data for a plurality of images; a layout information storage unit for storing layout information that specify display areas for the plurality of images on a monitor and specify, when the images overlaps, front-back relationships thereamong; one or more entire-image non-display memories for storing based on the layout information image data transferred from the non-display memory; a transfer control unit for, when at least one of the image data stored in the non-display memory is updated and if there exists a first image whose layout information specifies that the first image is displayed in front of a second image corresponding to the updated image data, arranging to transfer to the entire-image non-display memories the updated image data and image data for the first image; and one or more display buffers for storing image data for images, transferred from the entire-image non-display memories, to be displayed on the monitor.

According to the present invention, when image data stored in the non-display memory is updated and if there exists image data for a first image specified to be displayed in front of images corresponding to the updated image data, only these image data are transferred; therefore, overlapping images can be displayed with a simple configuration without a complicated rectangle area management such as a masking process.

### BRIEF DESCRIPTION OF DRAWINGS

FIG. 1 is a block diagram illustrating a configuration of a rendering display device of Embodiment 1;

FIG. 2 is a flow chart for explaining operations of an image data developing unit in Embodiment 1 and Embodiment 2;

FIG. 3 is a flow chart for explaining operations of an update information control unit in Embodiment 1;

FIG. 4 is a flow chart for explaining operations of a transfer control unit in Embodiment 1 and Embodiment 2;

FIG. 5 is a block diagram illustrating a configuration of an image writing unit in Embodiment 1;

FIG. 6 is a block diagram illustrating a configuration of the rendering display device of Embodiment 2;

FIG. 7 is a flow chart for explaining operations of an update information control unit in Embodiment 2.

### REFERENCE NUMERALS

2 transfer control unit
3 31 32 entire-image non-display memory
4 image writing unit
4A image data setting unit
5 monitor
8 color key setting unit
9 layer control unit
11 12 display buffer
301 302 303 non-display memory
501 502 503 layout information recording unit

### BEST MODE FOR CARRYING OUT THE INVENTION

The best mode for carrying out the invention will be explained in Embodiment 1 and Embodiment 2.

### Embodiment 1

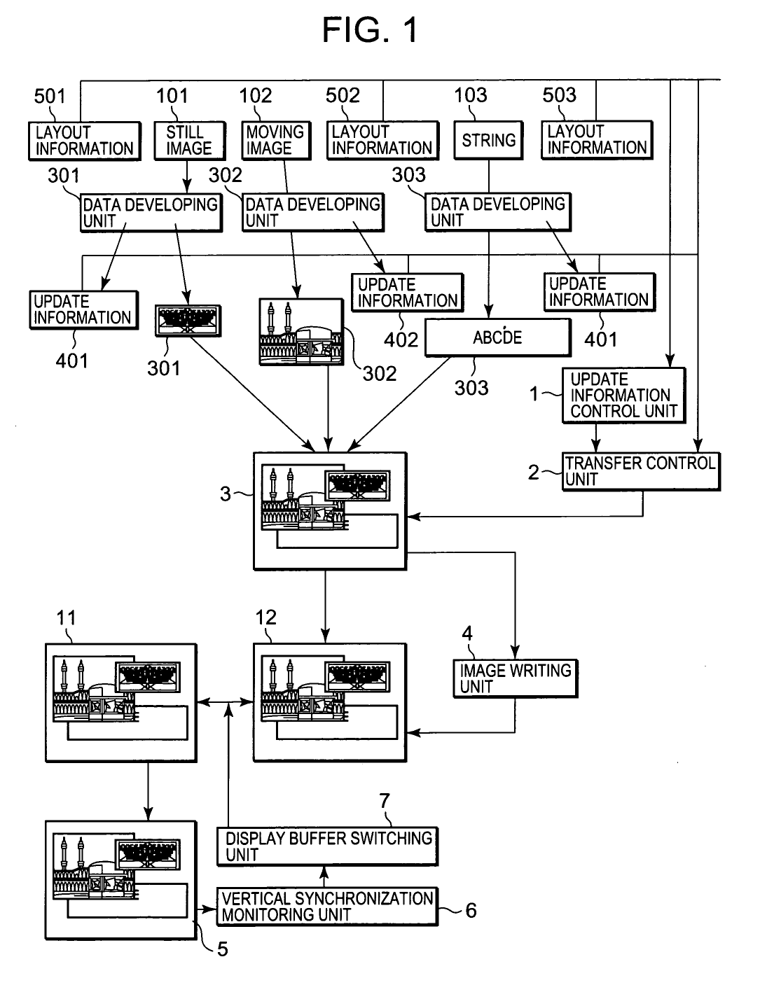

FIG. 1 is a block diagram illustrating a configuration of a rendering display device of Embodiment 1 according to the present invention. In FIG. 1, still image data 101, moving image data 102 and string image data 103 are developed by data developing units 201, 202 and 203 to be stored in non-display memories 301, 302 and 303, respectively. The data developing units 201, 202 and 203 also have a function that changes update information on image data, stored in update information recording units 401, 402 and 403, respectively. Layout information recording units 501, 502 and 503 save layout information that specifies display areas, on a monitor screen, of images corresponding to the still image data 101, the moving image data 102 and the string image data 103, respectively and specifies front-back relationships among the images when the images are overlapped. An update information control unit 1 informs a transfer control unit 2 of the updated information that is set ON among those stored in all of the update information recording units. The transfer control unit 2 arranges to transfer from each of the non-display memories into an entire-image non-display memory 3, image data corresponding to the update information of which the update information control unit 1 has informed the control unit. The entire-image non-display memory 3 saves image data transferred from the non-display memories, based on each layout information. An image writing unit 4 transfers the image data stored in the entire-image non-display memory 3 into one of display buffers 11 and 12, whose data is not currently displayed on the monitor 5. A vertical synchronization monitoring unit 6 monitors vertical synchronization signals from the monitor 5 to send in synchronization with vertical synchronization signals a switching request to a display buffer switching unit 7; the display buffer switching unit 7 switches the display buffers 11 and 12 in synchronization with the switching request, and switches image data for images to be displayed on the monitor 5.

Next, operations of the rendering display device with its configuration described above will be explained, in which images are displayed on the monitor 5 overlapped from the frontmost in the order of an image corresponding to the still image data 101, one corresponding to the moving image 102 and one corresponding to the string image data 103. Hereinafter, the followings are assumed to explain; the size of the monitor 5 is 1024×768; the still image data 101 has 200×100 pixels to be displayed with a reference point (700, 100); the moving image data 102 has 640×480 pixels to be displayed with a reference point (20, 50); the string image data 103 includes a string image to be displayed in an area of height×width—200×850—with a reference point (600, 150). Layout information saved in the layout information recording units 501, 502 and 503 specifies display areas for the still image, the moving image and the string image and front-back relationships thereamong when the images are overlapped. The layout information may be set to each of the image data in advance, or may be newly set by operations of a user of the rendering display device. Furthermore, explanations will be made under an assumption in which each layout information is set in such a way that the images corresponding to the still image data 101, the moving image 102 and the string image data 103 are overlapped from the frontmost on the monitor 5 in order to be displayed thereon; however, any overlapping state of the image data may be allowed. That is, the image corresponding to the still image data 101 may be set to be displayed on the backmost, or the image corresponding to the moving image data 102 may be set to be displayed on the backmost.

The data developing unit 201 develops the still image data 101 into the non-display memory 301 and also sets its update information ON in the update information recording unit 401 so as to inform the update information control unit 1 of the update information. In a similar way, the data developing units 202 and 203 develop the moving image data 102 and the string image data 103 into the non-display memories 302 and 303 and also set their update information ON in the update information recording units 402 and 403 so as to inform the update information control unit 1 of the update information. The non-display memories 301, 302 and 303 save the developed image data.

The update information control unit 1 is informed of the update information, and then informs the transfer control unit 2 of update information that has been set ON. The transfer control unit 2 arranges to transfer the image data, corresponding to the update information being informed of, out of image data stored in the non-display memories into areas in the entire-image non-display memory 3, specified by the layout information, so as to have the front-back relationships specified by the layout information. Now, all of the update information have been set ON, therefore all of the still image data 101, the moving image data 102 and the string image data 103 are transferred to the entire-image non-display memory 3. Furthermore, based on each of the layout information, the string image data 103 to be displayed at the backmost is transferred to the area with the reference point (600, 150); next, the moving image data 102 is transferred to the area with the reference point (20, 50); finally, the still image data 101 is transferred to the area with the reference point (700, 100). As a result, the entire-image non-display memory 3 stores image data for images in which the images corresponding to the still image data 101, the moving image data 102 and the string image data 103 are overlapped from the frontmost in that order.

Next, the image writing unit 4 transfers the image data stored in the entire-image non-display memory 3 into one of the display buffers 11 and 12, that stores image data for images not currently displayed on the monitor 5. Here, explanations will be made in a state where the image data in the entire-image non-display memory 3 has been transferred to the display buffer 11. The display buffer switching unit 7 switches image data for images to be displayed on the monitor 5 from the display buffer 12 to the display buffer 11, synchronizing with the switching signals from the vertical synchronization signal monitoring unit 6. By switching the display buffers in synchronization with the switching signals from the vertical synchronization signal monitoring unit 6, it becomes possible to switch the display buffers within a vertical synchronization period, resulting in a flicker-free image to be displayed.

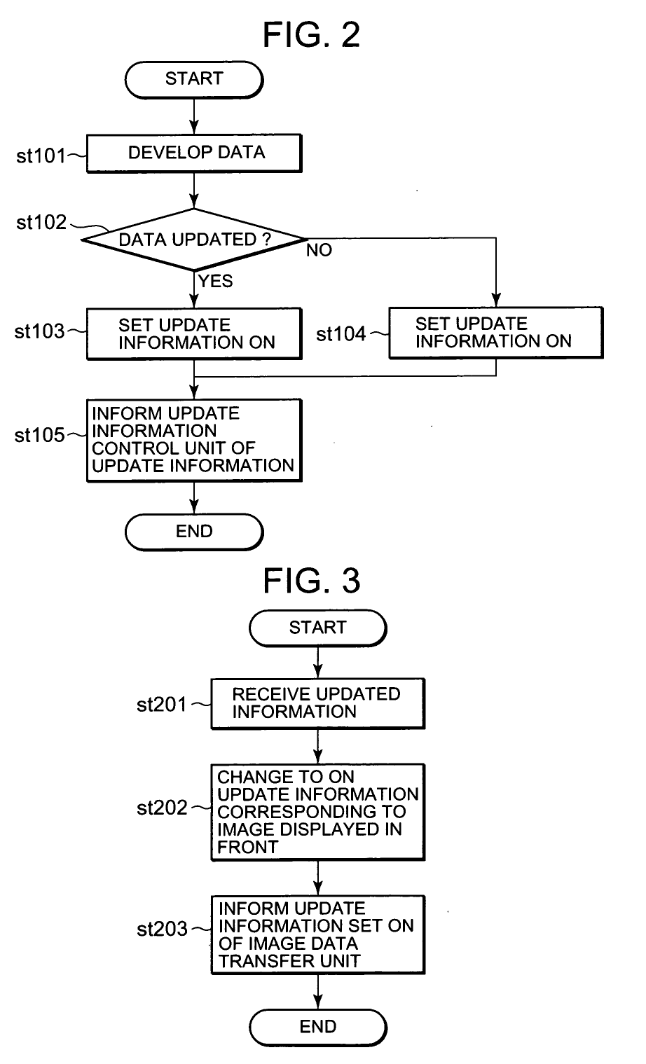

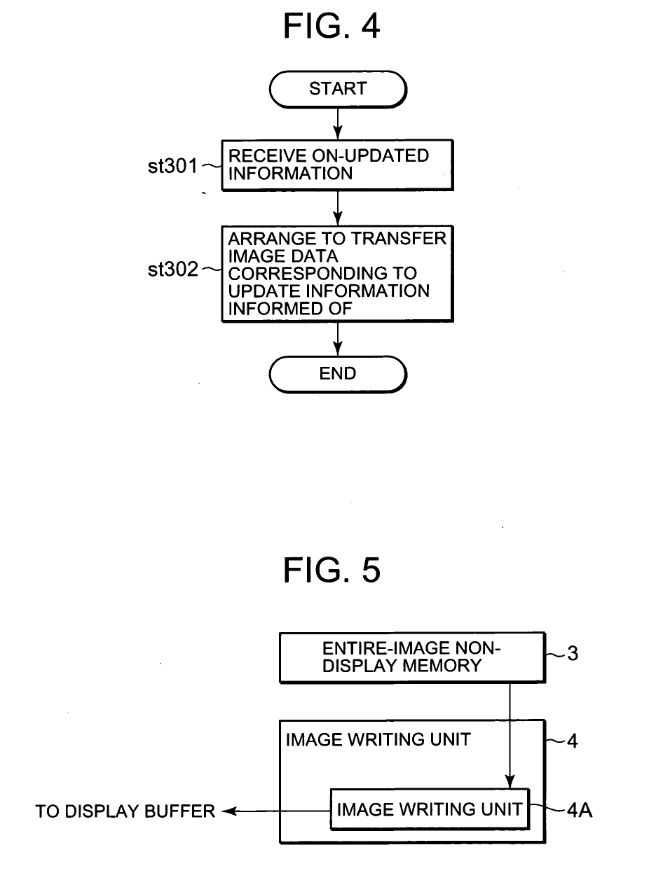

Next, in a case where the moving image data 102 is updated but the still image data 101 and the string image data 103 are not updated, operations will be explained using FIG. 2, FIG. 3 and FIG. 4. FIG. 2, FIG. 3 and FIG. 4 are flow charts for explaining operations, in this case, of the data developing units, the update information control unit 1 and the transfer control unit 2, respectively.

As described above, the data developing units 201, 202 and 203 develop the still image data 201, the moving image data 202 and the string image data 103 in the non-display memories 301, 302 and 303, respectively (st101). At the same time, each of the data developing units determines whether or not the image data developed in the non-display memory is updated (st102). Due to the determination, if the image data is updated, its update information is set ON (st103); if not, the update information is set OFF (st104). Here, the still image data 101 and the string image data 103 are not updated and only the moving image data 102 is updated; therefore, the update information in the update information recording units 401 and 403 are set OFF and the update information in the update information recording unit 402 is set ON. In addition, the data developing units each inform the update information control unit 1 of their update information (st105). The update information control unit 1 receives notifications of the update information (st201), and changes to ON-state update information of the image data for images whose layout information specifies that their images are displayed in the foreground of the images whose update information is ON (st202). Here, the update information of the moving image 102 is ON, and the layout information specifies that the image corresponding to the still image data 101 is displayed in the foreground of the image corresponding to the moving image data 101; therefore, in st202, the update information control unit 1 changes the update information of the still image data 101, stored in the update information recording unit 401, from OFF to ON. Next, the update information control unit 1 informs the transfer control unit 2 of the update information in the ON-state (st203).

The transfer control unit 2 receives notifications from the update information control unit 1 (st301), then arranges to transfer the image data, corresponding to the update information having been informed of, out of image data stored in the non-display memories, into areas in the entire-image non-display memory 3, specified by the layout information saved in the layout information recording units, so as to have the front-back relationships specified by the layout information (st302). In this case, only the still image data 101 stored in the non-display memory 301 and the moving image data 302 stored in the non-display memory 302 are transferred to the entire-image non-display memory 3. At this time, the string image data 103 stored in the entire-image non-display memory can be used as it is. The following operations are similar to those explained in paragraph 0014, with the result that the images are overlapped with one another to be displayed on the monitor 5.

In a rendering display device configured in a way described above, overlapping images can be displayed with a simple configuration without a complicated rectangle area management such as a mask process and necessary data update can be performed without flickers. Furthermore, even when image data of images to be displayed includes moving image data with different frame rates, images are displayed within a vertical synchronization period of the monitor 5; therefore, it brings an effect that images are displayed without flickers.

In addition, the image writing unit 4 may be configured as shown in FIG. 5, in which the image writing unit includes an image data setting unit 4A for changing the writing size and position of image data stored in the entire-image non-display memory 3 and transfers the image data changed by the image data setting unit 4A to the display buffer 11 or the display buffer 12. Such a configuration enables display operations of images displayed on the monitor 5 such as zooming in/out and scrolling.

Furthermore, images to be displayed are not limited to those described above. That is, a plurality of moving images may be configured to be displayed overlapping with one another on the monitor 5, and the number of images may be arbitrary. Furthermore, image update rates may be the same or different.

### Embodiment 2

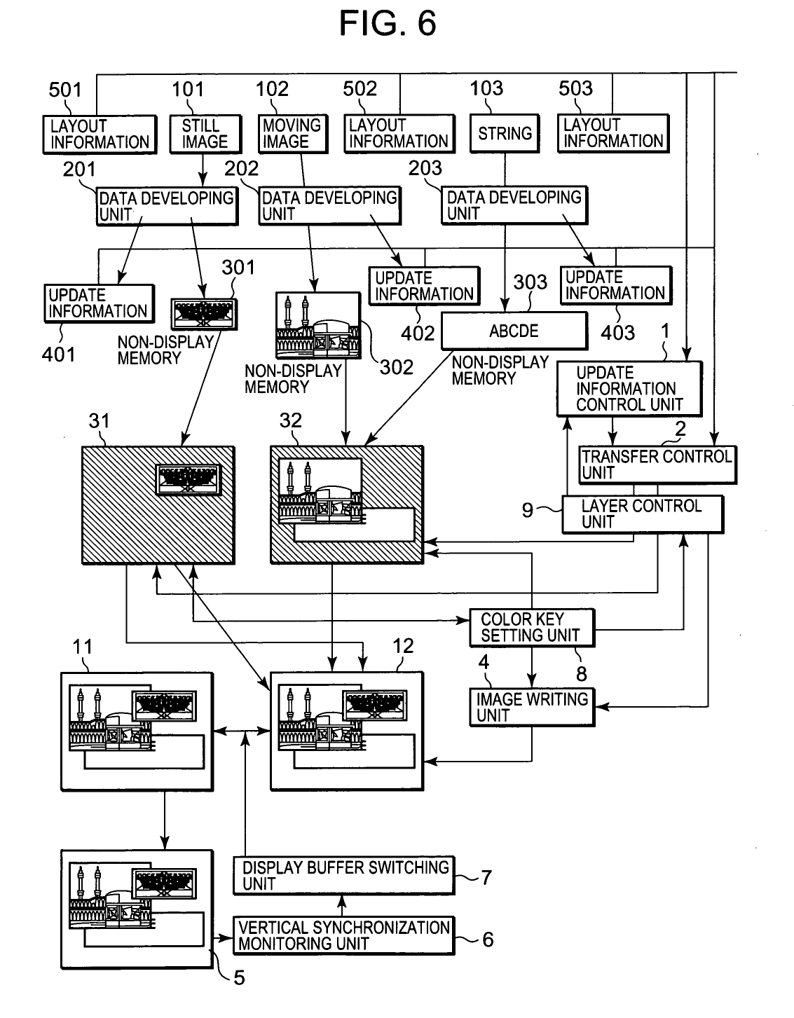

FIG. 6 is a block diagram illustrating a configuration of a rendering display device of Embodiment 2 according to the present invention. In FIG. 6, the components identical with those in FIG. 1 are referred to as the same numerals, and those explanations are eliminated. In FIG. 6, the image data stored in each of the non-display memories is transferred to either an entire-image non-display memory 31 or an entire-image non-display memory 32. A color key setting unit 8 sets a transparent color by which images are not transferred when transferred from the entire-image non-display memory 31 and the entire-image non-display memory 32 to either the display buffer 11 or the display buffer 12. A layer control unit 9 informs the transfer control unit 2 of transfer information that specifies to which entire-image non-display memory, the image data stored in each of the non-display memories is transferred. According to the transfer information and the layout information, the layer control unit also determines the order in which the image data stored in the entire-image non-display memory 31 and 32 are transferred to one of display buffers 11 and 12, to instruct the image writing unit 4.

Next, operations of the rendering display device configured as above will be explained in a way similar to that in Embodiment 1, in which images are displayed overlapped from the frontmost on the monitor 5 in the order of an image corresponding to the still image data 101, one corresponding to the moving image 102 and one corresponding to the string image data 103.

Similarly to Embodiment 1, the still image data 101, the moving image data 102 and the string image data 103 are transferred to the non-display memories 301, 302 and 303, respectively; update information stored in the update information recording units 401, 402 and 403 are all set ON. The update information control unit 1 informs the transfer control unit 2 of the update information in the ON-state. In a first-display stage to display all of the pixels for the first time on the monitor 5, the transfer control unit 2 fills with the transparent color specified by the color key setting unit 8 the background in the entire-image non-display memories 31 and 32, and specifies that the pixel data in this transparent color is not transferred to the display buffers. The color key setting unit 8 can set any color as the transparent color. When a pixel color is expressed in 24 bits-8 bits in each of R, G and B, the transparent color is set, for example, as a magenta expressed in RGB (255, 0, 255).

Next, the transfer control unit 2 arranges that image data corresponding to the update information notified of is transferred to an entire-image non-display memory that the layer control unit has selected out of the entire-image non-display memory 31 and the entire-image non-display memory 32. Here, explanations will be made in a case where the layer control unit 9 specifies that the still image data 101 stored in the non-display memory 301 is transferred to the entire-image non-display memory 31 and that the moving image data 102 and the string image data 103 stored in the non-display memory 302 and the non-display memory 303, respectively are transferred to the entire-image non-display memory 32. The update information control unit 1 is informed of the transfer information that indicates to which entire-image non-display memory the image data stored in each non-display memory is transferred. Therefore, the still image data 101 stored in the non-display memory 301 is transferred to the entire-image non-display memory 31 at a position specified by the layout information stored in the layout information recording unit 501; the moving image data 102 and the string image data 103 each stored in the non-display memories 302 and 303 are transferred to the entire-image non-display memory 32 at positions specified by the layout information each stored in the layout information recording units 502 and 503, having the front-back relationships specified in the layout information. As a result, the entire-image non-display memory 31 stores image data, with its background being the transparent color, for an image corresponding to the still image data 101 to be displayed; the entire-image non-display memory 32 stores image data, with its background having the transparent color, for images that are overlapped from the frontmost in the order of an image corresponding to the moving image 102 and one corresponding to the string image data 103. Furthermore, according to the layout information, the layer control unit 9 instructs the image writing unit 4 to transfer first the image data in the entire-image non-display memory storing the image data that is specified to be displayed behind. In this case, the image of the image data stored in the entire-image non-display memory 32 is specified so that the image is displayed behind that of the image data stored in the entire-image non-display memory 31; therefore, the layer control unit 9 instructs the image writing unit 4 to transfer image data in the order of the entire-image non-display memory 32 and the entire-image non-display memory 31.

Receiving the instruction from the layer control unit 9, the image writing unit 4 transfers the image data stored in the entire-image non-display memory 32 and the image data stored in the entire-image non-display memory 31 in that order, to one of the display buffer 11 and display buffer 12, that stores image data for an image not currently displayed on the monitor 5. In these operations, the data of pixels specified as the transparent color are not transferred. In addition, here, explanations will be made under an assumption where the image data in the entire-image non-display memories 31 and 32 have been transferred to the display buffer 11.

In this case, the entire-image non-display memory 11 stores image data for images, in which images are overlapped from the frontmost in the order of an image corresponding to the still image data 101, one corresponding to the moving image 102 and one corresponding to the string image data 103 and in which the transparent color becomes “transparent”. Then, similarly to the operations in Embodiment 1, the monitor 5 displays images corresponding to those of the image data stored in the display buffer 11.

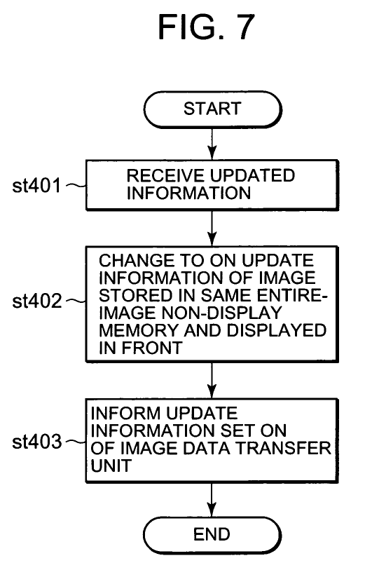

Next, in a case where the moving image data 102 is updated but the still image data 101 and the string image data 103 are not updated as in Embodiment 1, operations will be explained using FIG. 2 and FIG. 7. FIG. 7 is a flow chart for explaining operations, in this case, of the update information control unit 1. The data developing units each inform the update information control unit 1 of update information of each image data, through operations similar to st101 to st105 in Embodiment 1. The update information control unit 1 receives notifications of the update information (st401) and changes, according to the layout information stored in each of the layout information recording units and the transfer information from the layer control unit 9, to the ON-state the update information of the image data for images that are specified to be transferred to the same entire-image non-display memory as the image data with its update information data having being updated and to be displayed in front of the image of the image data with its update information having being updated (st402). At this moment, the transfer information specifies that the string image data 103 is also transferred to the entire-image non-display memory 32 to which the moving image data 102 with its update information being ON is transferred; however, because the layout information specifies that the image corresponding to the string image data 103 is displayed behind that corresponding to the moving image data 102, any of the update information is not changed. Next, the update information control unit 1 informs the transfer control unit 2 of the update information having the ON-state (st403).

According to the operations similar with st301 to st302 in Embodiment 1, the transfer control unit 2 arranges to transfer image data corresponding to the update information being informed of to the entire-image non-display memory. In this case, only the moving image data 102 stored in the non-display memory 302 is transferred to the entire-image non-display memory 32. At this time, the still image data 101 stored in the entire-image non-display memory 31 and the string image data 103 stored in the entire-image non-display memory 32 can be used as it is. The operations after that are similar to those explained in paragraph 0024, so that the images are overlapped with one another to be displayed on the monitor 5.

In the rendering display device configured in a manner described above, the quantity of data transferred from the non-display memories to the entire-image non-display memories can be reduced in comparison with that in the rendering display device in Embodiment 1. In particular, when a rarely updated image such as a still image data is displayed in front of a frequently updated image such as a moving image, it brings a great effect by specifying that the image data for the images each are transferred to different non-display memories.

The color key setting unit 8 may be configured to specify a transparent color or an alpha value for transmissivity, so that the image writing unit 4 transfers, using the transmissivity, image data stored in each of the entire-image non-display memories to the display buffer 11 or the display buffer 12. Such configurations enable the monitor 5 to display images overlapping translucently.

As described above, a rendering display device according to the present invention is suitable for displaying images overlapped with one another on a monitor

1. A rendering display device, comprising:
a non-display memory for storing image data for a plurality of images;
a layout information storage unit for storing layout information that specify display areas for the plurality of images on a monitor and specify, when the images overlaps, front-back relationships thereamong;
one or more entire-image non-display memories for storing based on the layout information image data transferred from the non-display memory;
a transfer control unit for, when at least one of the image data stored in the non-display memory is updated and if there exists a first image whose layout information specifies that the first image is displayed in front of a second image corresponding to the updated image data, arranging to transfer to the entire-image non-display memories the updated image data and image data for the first image; and
one or more display buffers for storing image data for images, transferred from the entire-image non-display memories, to be displayed on the monitor.

2. The rendering display device according to claim 1, wherein a plurality of display buffers is included, and the rendering device further comprises:
an image writing unit for transferring to one of the plurality of display buffers image data stored in the entire-image non-display memories; and
a display buffer switching unit for switching, in synchronization with vertical synchronization signals from the monitor, the plurality of display buffers storing images to be displayed on the monitor.

3. The rendering display device according to claim 1, wherein the image data writing unit includes an image data setting unit for changing image sizes and display positions related to image data stored in the entire-image non-display memories, and transfers to the display buffers image data changed by the image data setting unit.

4. The rendering display device according to claim 1, wherein the rendering display device includes a plurality of entire-image non-display memories and further comprises
a layer control unit for directing to which entire-image non-display memory, image data stored in the non-display memory is transferred; and
when image data stored in the non-display memory is updated and if there exists a third image whose image data is transferred by the layer control unit to the same entire-image non-display memory as the updated image data and that is specified by its layout information to be displayed in the foreground of the updated image, the transfer control unit arranges to transfer the image data for the third image and the updated image data.

5. The rendering display device according to claim 4, further comprising
a color key setting unit for setting a transparent color or a transmissivity to image data to be transferred to the non-display memories, wherein the transfer control unit arranges to transfer image data, in accordance with the transparent color or the transmissivity.
